(19) United States
(12) Patent Application Publication
(10) Pub. No.: US 2016/0063560 A1
(43) Pub. Date: Mar. 3, 2016

(54) ACCELERATING ENGAGEMENT OF POTENTIAL BUYERS BASED ON BIG DATA ANALYTICS

(71) Applicant: LinkedIn Corporation, Mountain View, CA (US)

(72) Inventors: Saad Hameed, Fremont, CA (US); Shaobo Liu, Belmont, CA (US)

(21) Appl. No.: 14/579,806

(22) Filed: Dec. 22, 2014

Related U.S. Application Data
(60) Provisional application No. 62/044,688, filed on Sep. 2, 2014.

(51) Int. Cl. G06Q 30/02; G06Q 10/06

(52) U.S. Cl. CPC G06Q 30/0264; G06Q 30/0269; G06Q 10/067

(57) ABSTRACT

A machine may be configured to accelerate the engagement of a user in a buying cycle. For example, the machine determines a level of engagement of particular member of a social networking service (SNS) with a seller entity that offers a product or service for sale. The machine selects an item of digital content that is determined to have a high likelihood of increasing the level of engagement of the particular member. The machine identifies an optimal communication channel for presenting the item of digital content to the particular member. The machine determines an optimal time to present the item of digital content to the particular member. The machine causes a display of a particular device associated with the particular member to present the item of digital content in a user interface of the particular device via the optimal communication channel at the optimal time.

### CLAIM OF PRIORITY

This application claims the benefit of priority, under 35 U.S.C. Section 119(e), U.S. Provisional Patent Application No. 62/044,688 (Attorney Docket No. 3080.C65PRV) by Hameed et al., filed on Sep. 2, 2014, which is hereby incorporated herein by reference in its entirety.

### TECHNICAL FIELD

The present application relates generally to the processing of data, and, in various example embodiments, to systems, methods, and computer program products for accelerating the engagement of a potential buyer in a buying cycle based on big data analytics.

### BACKGROUND

Traditionally, in an attempt to sell a product or a service, a salesperson may contact one or more people in a list of “leads” (e.g., potential purchasers) and may make one or more sales pitches. While interacting with a potential buyer, the salesperson may identify whether the potential buyer has a problem that the product or service available for sale may solve. The salesperson then may describe to the potential buyer the benefits of the product or service and how the product or service may provide a solution to the potential buyer's problem.

The frequent lack of sufficient information about the leads may make this traditional sales approach ineffective. In some instances, when a sales pitch is made too soon to a potential buyer (e.g., when the potential buyer is not aware of the problem or is not ready to make a decision to purchase), the opportunity to make a sale to that potential buyer may be lost. Similarly, the opportunity to make a sale may be lost when a sales pitch is addressed to a lead who is not a decision maker.

### BRIEF DESCRIPTION OF THE DRAWINGS

Some embodiments are illustrated by way of example and not limitation in the figures of the accompanying drawings, in which:

FIG. 1 is a network diagram illustrating a client-server system, according to some example embodiments;

FIG. 2 is a diagram that illustrates the data flow in an engagement accelerating system, according to some example embodiments;

FIG. 3 is a diagram that illustrates the data flow in an engagement accelerating system, according to some example embodiments;

FIG. 4 is a block diagram illustrating components of an engagement accelerating system, according to some example embodiments;

FIG. 5 is a block diagram illustrating components of a content identifying module of the engagement accelerating system illustrated in FIG. 4, according to some example embodiments;

FIG. 6 is a flowchart illustrating a method of accelerating engagement of a buyer based on big data analytics, according to some example embodiments;

FIG. 7 is a flowchart illustrating a method of accelerating engagement of a buyer based on big data analytics, and represents the steps 604 and 606 of the method illustrated in FIG. 6 in more detail, according to some example embodiments;

FIG. 8 is a flowchart illustrating a method of accelerating engagement of a buyer based on big data analytics, and represents the step 606 of the method illustrated in FIG. 6 in more detail, according to some example embodiments;

FIG. 9 is a flowchart illustrating a method of accelerating engagement of a buyer based on big data analytics, and represents the step 604 of the method illustrated in FIG. 6 in more detail, according to some example embodiments;

FIG. 10 is a flowchart illustrating a method of accelerating engagement of a buyer based on big data analytics, and represents the step 610 of the method illustrated in FIG. 6 in more detail, according to some example embodiments;

FIG. 11 is a block diagram illustrating a mobile device, according to some example embodiments; and

FIG. 12 is a block diagram illustrating components of a machine, according to some example embodiments, able to read instructions from a machine-readable medium and perform any one or more of the methodologies discussed herein.

### DETAILED DESCRIPTION

Example methods and systems for accelerating the engagement of a potential buyer in a buying cycle based on big data analytics are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

Traditionally, a potential buyer considering purchasing a product or subscribing to a service may interact with a salesperson to learn about the product or service. The recent proliferation of various online sources of information and the ease of creating and posting online content promoting products or services has changed the way potential buyers obtain information about products or services. Today, consumers or potential purchasers of products or services often prefer to perform their own research of problems and potential solutions using the vast informational resources available on the Internet. The change in how potential buyers inform themselves about products or services may lead to a shift in the traditional sales paradigm. To successfully sell their products or services, organizations (e.g., companies, businesses, etc.) may adopt a new way of selling to potential buyers who today may be better informed, more independent in a buying cycle, and more active in sharing information learned about products or service (e.g., within their social networks).

In some example embodiments, an engagement accelerating system may identify and educate a user about a problem he might have (e.g., searching for a new job, searching for a candidate to fill a job opening, etc.) and may identify the product or service that is most suitable to solve or assist in solving the user's problem. The user may be a potential buyer or an actual buyer of one or more products or services. In some example embodiments, the user is a member of a social networking service (also “SNS”), such as LinkedIn®.

The engagement accelerating system may select and deliver content (e.g., marketing content, marketing output, etc.) to the user to increase the user's engagement (e.g., readiness to buy a product or service) in a buying cycle. The selection of the item of content (e.g., the item of digital content) may be based on big data analytics of data pertaining to a plurality of users (e.g., the potential buyer, actual buyers of the selected or other products or services, etc.), business data pertaining to the seller of the product or service, or both. In some instances, the engagement accelerating system may remove the personally identifiable information (PII) from the user data pertaining to the plurality of the users before the user data is analyzed by the engagement accelerating system. In certain example embodiments, the user data analyzed by the engagement accelerating system is stored without the PII in one or more databases accessed by the engagement accelerating system.

The engagement accelerating system may determine the level of engagement of a user (e.g., a potential buyer) with a company (e.g., with the products or services sold by the company, marketing output or news feeds generated by or for by the company, the employees of by the company, etc.). In some instances, when the user is highly (e.g., fully) engaged, the engagement accelerating system may determine in real time a propensity of the user to purchase certain types of products or services, such as the products or services associated with a particular business unit (e.g., Sales, Marketing, or Human Resources). The engagement accelerating system may also identify the optimal buying channel for the user (e.g., online or via a salesperson). The engagement accelerating system may determine a product or service of one or more products or services in the particular business unit, that the user may be interested in purchasing (e.g., via the optimal buying channel).

The engagement accelerating system may also determine the level of awareness of the user with respect to one or more products or services associated with (e.g., in) the business unit. In some example embodiments, the engagement accelerating system may determine the product or service of the one or more products or services that should be promoted (e.g., offered for sale) to the user based on the level of awareness of the user with respect to one or more products or services.

The engagement accelerating system may then identify an item of content to be communicated to the user based on the level of awareness of the user with regards to the product or service the user might be interested in. In order to increase the chances of the user consuming (e.g., interacting with, reading, engaging with, etc.) the selected content, the engagement accelerating system may determine the best communication channel via which to present the item of content to the user and the best time (e.g., time of day and day of the week) to present the respective item of content. For example, the engagement accelerating system determines that a particular member of the SNS opens email messages recently received from the SNS, between 9 a.m. and 10 a.m. on Mondays. The engagement accelerating system may transmit an item of digital content in an email message addressed to the particular member about 9 a.m. on a Monday. This increases the likelihood that the particular member will open the email message and read the item of digital content displayed in a user interface of a device associated with the particular member.

In certain example embodiments, when the user is either disengaged or moderately engaged, the engagement accelerating system may identify the optimal item of content to be presented to the particular user based on a buying cycle phase that the user is associated with, the optimal communication channel for the particular user, and the optimal time to present the optimal item of content to the particular user via the optimal communication channel. The use of the optimal channel of communication and optimal time of communication with the particular user may facilitate a “warmer” reception of the item of content by the particular user.

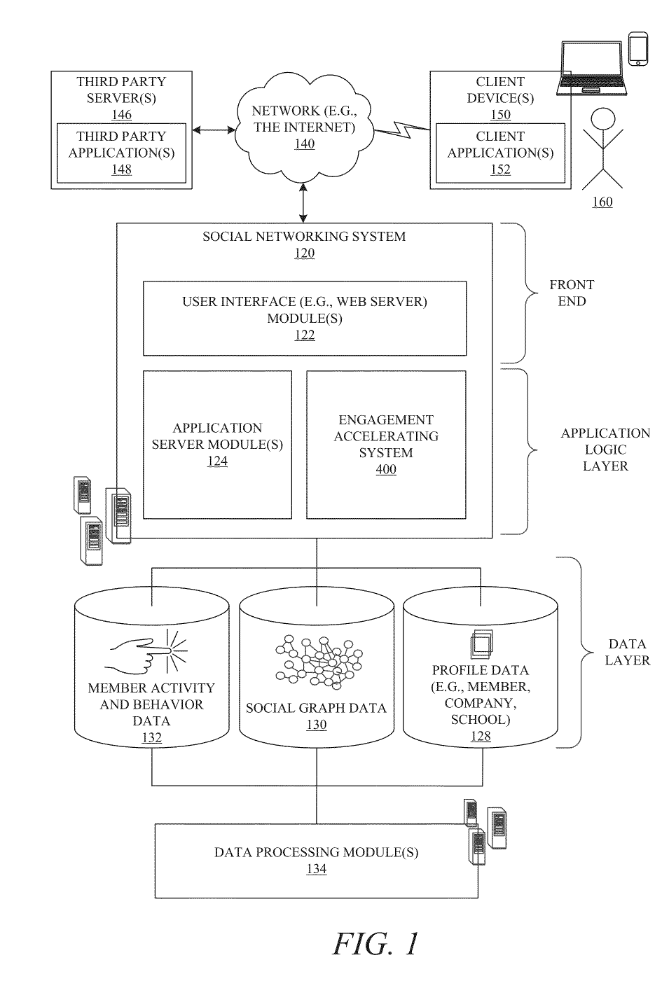

An example method and system for accelerating engagement of a buyer in a buying cycle may be implemented in the context of the client-server system illustrated in FIG. 1. As illustrated in FIG. 1, the engagement accelerating system 400 is part of the social networking system 120. As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™ Windows® Phone).

For example, client device(s) 150 may be executing client application(s) 152. The client application(s) 152 may provide functionality to present information to the user and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of a social graph. In some example embodiments, a “social graph” is a mechanism used by an online social networking service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. Of course, with various alternative embodiments, any number of other entities may be included in the social graph, and as such, various other databases may be used to store data corresponding to other entities.

Consistent with some embodiments, when a person initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members interact with various applications, content, and user interfaces of the social networking system 120, information relating to the member's activity and behavior may be stored in a database, such as the database 132.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social networking service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130.

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, social networking system 120 may include the engagement accelerating system 400, which is described in more detail below.

Further, as shown in FIG. 1, a data processing module 134 may be used with a variety of applications, services, and features of the social networking system 120. The data processing module 134 may periodically access one or more of the databases 128, 130, or 132, process (e.g., execute batch process jobs to analyze or mine) profile data, social graph data, or member activity and behavior data, and generate analysis results based on the analysis of the respective data. The data processing module 134 may operate offline. According to some example embodiments, the data processing module 134 operates as part of the social networking system 120. Consistent with other example embodiments, the data processing module 134 operates in a separate system external to the social networking system 120. In some example embodiments, the data processing module 134 may include multiple servers, such as Hadoop servers for processing large data sets. The data processing module 134 may process data in real time, according to a schedule, automatically, or on demand.

In some example embodiments, the data processing modules 134 may perform an analysis of profile data associated with a plurality of members of the social networking service. For example, the data processing module 134 may analyze the data pertaining to the behavior of a user (e.g., website pages viewed, number of days during a period of time that the user visited a website, etc.) and determine the engagement level of the user in a buying cycle. The results of the analyses performed by the data processing module 134 may be stored for further use, in one or more of the databases 128, 130, or 132, or in another database.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

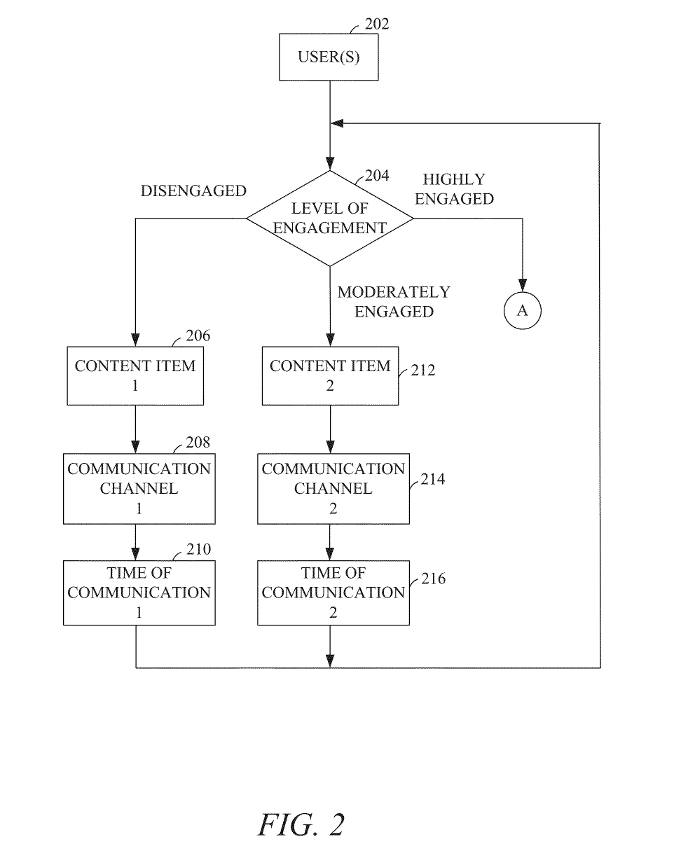

FIG. 2 is a diagram that illustrates the data flow in an engagement accelerating system 400, according to some example embodiments. As shown in FIG. 2, the engagement accelerating system 400 may examine data pertaining to the user 202 and determine, at step 204 of the diagram of FIG. 2, the level of engagement of the user 202. In some example embodiments, the user 202 is a member of a social networking service provided by the social networking system 120, and the data analyzed by the engagement accelerating system 400 pertains to the member of the social networking service. Such data may be profile data 128, social graph data 130, member activity and behavior data 132, or a suitable combination thereof.

The engagement accelerating system 400 may determine that the user 202 is disengaged, is moderately engaged, or is highly engaged. In some example embodiments, engagement accelerating system 400, using a logistic regression model, generates an engagement index pertaining to one or more users to determine the level of engagement of each user (e.g., disengaged user, moderately engaged user, or fully engaged user). In certain example embodiments, the level of engagement of a user is determined based on a number of logins by the particular member, a number of page views by the particular member, a number of days the particular member visited a website or a store during a period of time (e.g., a month, a year, etc.), a number of connections of the particular member on the SNS, a number of invites to connect sent by the particular member, a number and a type of searches performed by the particular member, a geographical region identifier, or a preferred language identifier, or a suitable combination thereof. The websites visited or logged into by the member may or may not be associated with the SNS. In various example embodiments, the level of engagement of a user is determined based on other metrics or values (e.g., interests of the user).

A user who is disengaged or is moderately engaged is likely to not be ready to make a purchase. In some example embodiments, the engagement accelerating system 400 may compute an individual interest score for the user 202 based on interactions by the user 202 with items of content (e.g., certain marketing output) and determine the level of engagement of the user 202 based on the individual interest score of the user 202.

If the user 202 is determined to be disengaged, the engagement accelerating system 400 may identify one or more items of content to be presented to the user 202 to increase the level of engagement of the user 202 within the user's buying cycle. For example, the engagement accelerating system 400 may analyze behavior data of other users who were previously presented various items of content and, based on the results of the analysis, identify an item of content for the user 202 such that there is a high likelihood that the user 202 may transition from being disengaged to being moderately engaged. In some instances, the behavior data of other users that is analyzed is limited to other users who are determined to have one or more similar attributes as the user 202 (e.g., have the same job title, seniority, are employed in the same department as the user 202, are connected to the user 202 via the SNS, etc.). Accordingly, the determination of the optimal item of content 206 (e.g., content item 1) to be presented to the user 202 may be based on an analysis (e.g., a cluster analysis) of data pertaining to users like (e.g., similar to, sharing one or more attributes or characteristics with) the user 202 and their consumption of items of content. For example, if the users identified to share certain characteristics with the user 202 care about value, then the optimal item of content 206 may discuss value.

The engagement accelerating system 400 may determine the optimal communication channel 208 (e.g., communication channel 1) to communicate the content item 206 to the user 202. Examples of communication channels are types of media such as InMails, emails, ads, YouTube videos, articles, blog posts, targeted messages when users log into a website, etc. In some example embodiments, the best communication channel to be used for user 202 may be determined using a logistic regression model of channel effectiveness. In certain example embodiments, the best communication channel to be used for user 202 may be determined based on a decision tree model of past channel activity. Examples of data utilized by the model for selecting the optimal communication channel for the user 202 are a number of email message openings, a click-through rate (e.g., associated with email messages), a number of form submissions from a website, a number of a webinar registrations or attendances, a number of seminar or tradeshow registrations or attendances, a number of social media clicks, mentions, shares, or likes. Other types of data that may be utilized by the model for selecting the optimal communication channel for the user 202 are a number of unsubscribes associated with one or more communication channels, a conversion rate associated with the one or more channels, a department identifier, a number of employees associated with a company that is an employer of the one or more members, a revenue number associated with the company, a title identifier of the one or more members, an identifier of a decision making (DM) authority of the one or more members associated with the company, a geographical region identifier, or a preferred language identifier, or a suitable combination thereof.

The engagement accelerating system 400 may determine the optimal time of communication 210 (e.g., time of communication 2) to present the content item 206 to the user 202. The user 202 may have a pattern of consuming content (e.g., the user 202 reads emails at 9 a.m. every morning). The engagement accelerating system 400 may identify the time of day, the day of the week, or both, when it is best to present content to the user 202 to increase the likelihood that the user 202 may read or interact with the presented content. In some instances, the engagement accelerating system 400 accounts for a particular season, impending holidays, or events identified in a calendar associated with the user 202. The optimal time to present (e.g., transmit, deliver, display, etc.) content to the user 202 may be determined using a logistic regression model or a decision tree model. Examples of data utilized by the model for selecting the optimal time of communicating content to the user 202 are an identifier of a decision making authority of the one or more members associated with a company that is an employer of the one or more members, a geographical region identifier, a time zone identifier, a department identifier, an identifier of a size of a company that is an employer of the one or more members, a revenue number associated with the company, a title identifier of the one or more members, a season identifier, a holiday identifier, an identifier of a particular unavailability of the one or more members.

In certain example embodiments, after transmitting the content item 206 to the user 202 (e.g., a device associated with the user 202), the engagement accelerating system 400 re-determines the level of engagement of the user 202. If the user 202 is determined to continue to be disengaged, the engagement accelerating system 400 may select a further item of content 206 to transmit to the user 202. In some instances, a plurality of items of content 206 may be pre-determined and ordered for the purpose of being communicated in a particular order to increase the level of engagement of the user 202.

Similarly, if the user 202 is determined to be moderately engaged, the engagement accelerating system 400 may identify one or more items of content 212 (e.g., content item 2) to be presented to the user 202 to increase the level of engagement of the user 202 within the user's buying cycle (e.g., transition the user 202 from being moderately engaged to being fully engaged). The engagement accelerating system 400 may determine the optimal communication channel 214 (e.g., communication channel 2) to communicate the content item 212 to the user 202. The engagement accelerating system 400 may determine the optimal time of communication 216 (e.g., time of communication 2) to transmit the content item 212 to the user 202. As illustrated in FIG. 2, the engagement accelerating system 400 may determine that the user 202 is highly engaged. The functionalities of the engagement accelerating system 400 regarding highly engaged users is described in more detail below.

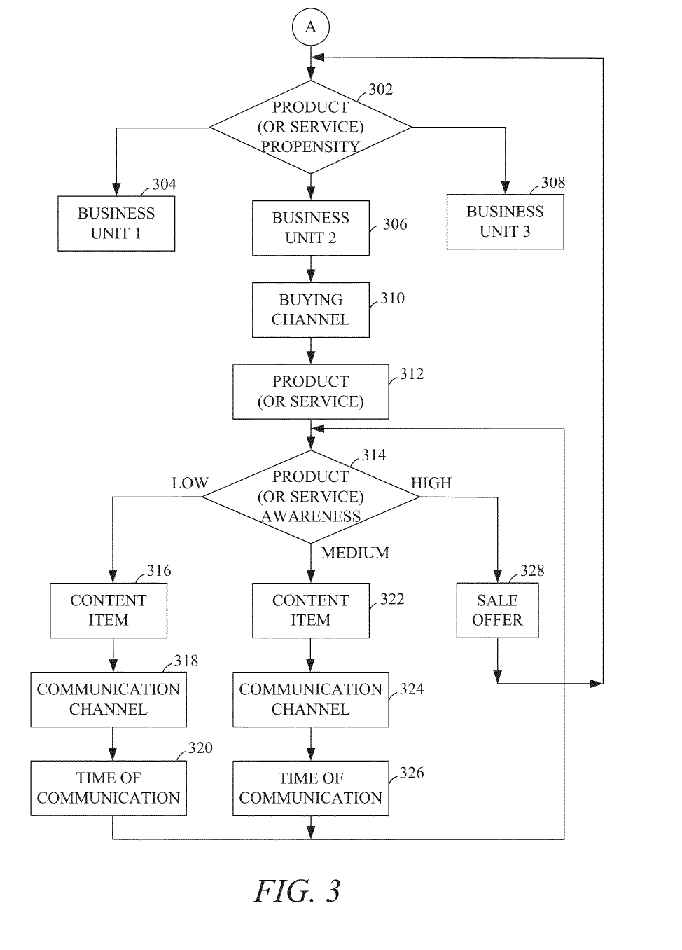

FIG. 3 is a diagram that illustrates the data flow in an engagement accelerating system 400, according to some example embodiments. As shown in FIG. 3, if the user 202 is categorized as a highly-engaged user, the engagement accelerating system 400 may determine, at step 302, a propensity of the user 202 to purchase certain types of products or services, such as the products or services associated with a particular business unit (e.g., business unit 1 304, business unit 2 306, or business unit 2 308). A business unit may be associated with (e.g., include) one product or service, or a plurality of related products or services (e.g., a number of products usable by Human Resources departments). In some instances, the plurality of products or services may differ in the types of solutions they offer. In certain instances, the plurality of products or services may differ in the number of functionalities offered to the buyers. For example, a first product or service (e.g., an enterprise version) may offer more features than a second product or service (e.g., a small business version).

According to various example embodiments, to determine the propensity of the user 202 to purchase certain types of products or services, the engagement accelerating system 400 employs a logistic regression model applied to data pertaining to users who already purchased the company's products or services. In some example embodiments, the engagement accelerating system 400 bases the determination of the propensity to purchase certain types of products or services on the identity of the user 202. For example, if the profile data (e.g., the title) of the user 202 indicates that the user 202 might be a recruiter, then the engagement accelerating system 400 identifies the business unit as “Talent Solutions.”

In certain example embodiments, the engagement accelerating system 400 may determine the propensity to purchase certain types of products or services based on previous use by the user 202 of products or services from the business unit. For example, the engagement accelerating system 400 may track the use of a software-as-a-service product at a previous job based on a member profile identifier (ID) of the user 202. The member profile ID of the user 202 may be associated (e.g., in a record of a database) with one or more instances of previous use of the software-as-a-service product. In some example embodiments, the engagement accelerating system 400 may determine the propensity to purchase certain types of products or services based on the geographic location of the user 202 or the data pertaining to the social network (e.g., on a social networking service) of the user 202, or a suitable combination of the factors described above.

The data pertaining to the network of connections (also “the social network”) of the user 202 may facilitate the inferring of information about the user 202 based on analyzing the data available for the connections of the user 202. For example, if the user 202 lists “engineer” as his title and if the user 202 is connected to ten software engineers and two mechanical engineers on a social networking service, the engagement accelerating system 400 makes an inference that the user 202 is more likely to be a software engineer. As such, the engagement accelerating system 400 may derive characteristics about the user 202 (e.g., the title of the user 202) based on his associations to other users (e.g., other members of the social networking service).

In some example embodiments, upon determining that the user 202 has a propensity to purchase products or services in the business unit 306, the engagement accelerating system 400 identifies the optimal buying channel 310 for the user. The engagement accelerating system 400 may determine whether the selling to (or, in some instances, the pre-sales nurturing of) the user 202 may be better to be performed via a particular buying channel. A buying channel may represent where or how a user may purchase a product or service. For example, the user 202 may buy a subscription for a service on a website and pay for the subscription in monthly installments using a credit card. Alternatively, the user 202 may use a subscription that covers a plurality of users, purchased by the employer of the plurality of users and paid for in one lump sum by the employer. The determination of the buying channel may be based on a variety of factors.

In some example embodiments, the engagement accelerating system 400 determines the buying channel appropriate for the user 202 based on one or more seller variables and one or more buyer variables. Examples of seller variables are profit, user lifetime value (also “LTV”), etc. The LTV may be a prediction of the net profit attributed to the entire future relationship with a customer.

The engagement accelerating system 400 may use the seller variables to determine which of the buying channels available to the user 202 is the most beneficial to the seller of the products or services in the business unit 306.

Examples of buyer variables are a propensity of the user 202 to buy from a type of channel (e.g., the user 202 prefers to purchase items online rather than in stores), a persona of the user 202, the social network of the user 202 (e.g., on a social networking service), the company where the user 202 works, etc. The propensity to buy from a type of channel may be determined based on an analysis (e.g., a cluster analysis) of the data pertaining to people similar to the user 202. Users may be similar to the user 202 if they share one or more characteristics with the user 202, such as users in the social network of the user 202, users who work at the same company as the user 202, users with the same or similar title as the user 202, etc. The propensity to buy from a type of channel may also be determined based on the geographic location associated with the user 202. For example, if the user 202 lives in a remote location where a retailer does not have a store, the engagement accelerating system 400 may infer that the user 202 has a propensity to buy items from the retailer online rather than in a retailer's store.

In some example embodiments, the engagement accelerating system 400 may associate the user 202 with a persona of the user 202. The engagement accelerating system 400 may associate the employer of the user 202 with a persona of the employer of the user 202. In some instances, the engagement accelerating system 400 associates the user 202 with the persona of the employer of the user 202. In some example embodiments, the persona of a user or the persona of the employer of a user is generated based on a K-Means model and various data pertaining to the user or to the employer of the user.

A user's persona may include a variety of information pertaining to the user, such as a title, an income number, a seniority identifier, various demographic data (e.g., age, gender, marital status, etc.), data pertaining to the behavior of the user (e.g., clicks on ads, interests, etc.), data pertaining to the company where the user is employed (e.g., the size and industry, the department in which the user works, the user's decision making authority, etc.), the geographic location associated with the user, data pertaining to the social network of the user on a SNS (e.g., the number of connections, the identities of the connections, a breadth of the social network, a depth of the social network, etc.), a current and past roles of the user, a current and past departments where the user worked, an identifier of a decision making authority of the user, a number of years of experience, an education level value, a stated or inferred professional goal (or intent) of the user, identifiers of industries where the user worked, identifiers of technical skills, or identifiers of non-technical skills. In some example embodiments, the user's persona also includes an account interest score for a particular product or service, associated with the company where the user works. The account interest score may represent the likelihood that the company will purchase the particular product or service.

In some example embodiments, an indicator of the breadth of the user's social network may be determined by the engagement accelerating system 400 based on the geography, departments, companies, industries associated with the other members in the social network of the user 202. In various example embodiments, an indicator of the depth of the user's social network may be determined by the engagement accelerating system 400 based on the decision making authority of the other members in the social network of the user 202. In some example embodiments, the professional goal (or intent) of the user may be inferred by the engagement accelerating system 400 based on behavior data associated with the user 202. For example, if the engagement accelerating system 400 determines that the user 202 made one or more job search requests (e.g., by using a search engine of the social networking system 120), the engagement accelerating system 400 identifies the user 202 as a job seeker, or makes the inference that the professional goal of the user 202 is to find a job. According to another example, if the engagement accelerating system 400 determines that the user 202 sent one or more email messages that include sales or promotional content, the engagement accelerating system 400 identifies the user 202 as a sales person, or makes the inference that the professional goal of the user 202 is to sell a product or service.

A persona of the employer of a user may include a variety of information pertaining to the employer of the user, such as a number of employees, a number of new hires during a period of time, an indicator of employee churn, a revenue value, a growth-in-revenue value, a growth-in-number-of-employees value, an industry identifier, a region identifier, a department identifier, a current role of the user, a current title of the user, or a current decision making authority of the user. In some example embodiments, the engagement accelerating system 400 determines the growth-in-revenue value based on comparing revenue values for different periods of time (e.g., two consecutive years). In certain example embodiments, the engagement accelerating system 400 determines the growth-in-number-of-employees value based on comparing the number of employees of the employer for different periods of time (e.g., two consecutive years).

The engagement accelerating system 400 may identify a product or service 312 of one or more products or services in the particular business unit 306 that the user may be interested in purchasing (e.g., via the optimal buying channel). The determining of the product or service 312 may be performed before or after the determining of the buying channel 310.

The engagement accelerating system 400 may identify a product or service 312 based on past use of the product or service 312 by the user 202, the social network of the user 202 (e.g., certain users in the social network of the user 202 are users of the product or service 312), the consumption by the user 202 of items of content pertaining to the product or service 312, and an individual interest score computed for the user 202 based on interactions by the user 202 with one or more items of content pertaining to the product or service, or a suitable combination thereof.

The engagement accelerating system 400 may then determine the level of awareness 314 of the user 202 with respect to the identified product or service 312. In some example embodiments, the engagement accelerating system 400 determines the level of awareness of the product or service 312 based on past use of the product or service 312 by the user 202, the social network of the user 202 (e.g., certain users in the social network of the user 202 are users of the product or service 312), the consumption by the user 202 of items of content pertaining to the product or service 312, an individual interest score computed for the user 202 based on interactions by the user 202 with one or more items of content pertaining to the product or service, or a suitable combination thereof.

In some example embodiments, the engagement accelerating system 400 categorizes the user into one of three classes based on the identified level of awareness of the user 202 with respect to the product or service 312: low awareness, medium awareness, or high awareness. The engagement accelerating system 400 may then identify an optimal item of content to be communicated to the user 202 based on the level of awareness 314 of the user 202 with regards to the product or service 312.

For example, if the user 202 is identified to have a low level of awareness 314 of the product or service 312, the engagement accelerating system 400 identifies (e.g., selects) the content item 316 to be communicated to the user 202 to increase his level of awareness of the product or service 312 (e.g., from low awareness to medium awareness). In order to increase the chances of the user consuming (e.g., interacting with, reading, engaging with, etc.) the selected content item 316, the engagement accelerating system 400 may determine an optimal communication channel 318 via which to transmit the item of content 316 to the user 202. Also, the engagement accelerating system 400 may determine an optimal time of communication 320 (e.g., time of day and day of the week) to transmit the item of content 316 to the user 202. The identifying of the optimal item of content 316, the optimal communication channel 318, and the optimal time of communication 320 are performed similarly to the identifying of the optimal item of content 206, the optimal communication channel 208, and the optimal time of communication 210 described above with respect to FIG. 2.

Similarly, if the user 202 is identified to have a medium level of awareness 314 of the product or service 312, the engagement accelerating system 400 identifies (e.g., selects) the content item 322 to be communicated to the user 202 to increase his level of awareness of the product or service 312 (e.g., from medium awareness to high awareness). In order to increase the chances of the user consuming (e.g., interacting with, reading, engaging with, etc.) the selected content item 322, the engagement accelerating system 400 may determine an optimal communication channel 324 via which to transmit the item of content 322 to the user 202. Also, the engagement accelerating system 400 may determine an optimal time of communication 326 (e.g., time of day and day of the week) to transmit the item of content 322 to the user 202. The identifying of the optimal item of content 322, the optimal communication channel 324, and the optimal time of communication 326 are performed similarly to the identifying of the optimal item of content 206, the optimal communication channel 208, and the optimal time of communication 210 described above with respect to FIG. 2.

According to various example embodiments, upon transmitting a content item (e.g., the item of content 316 or the item of content 322) to the user 202, the engagement accelerating system 400 re-evaluates (e.g., re-determines) the level of awareness of the user 202 with respect to the product 314. If the user 202 is identified to continue to have a low or a medium level of awareness with respect to the product or service 312, the engagement accelerating system 400 may communicate a further content item 316 or 322, respectively, to increase the level of awareness 314 of the user 202. In some example embodiments, the engagement accelerating system 400 utilizes machine learning methodologies to determine the next item of content to be transmitted to the user 202 based on user action or inaction with respect to the previously transmitted item(s) of content. Consistent with some example embodiments, the engagement accelerating system 400 performs cluster analysis of the data pertaining to users similar to the user 202 to identify a series of items of content to be presented to the user 202 based on the level of awareness of the user 202 and an order of presentation of the series of items of content.

For example, if the user 202 did not open an email including the item of content 316, the engagement accelerating system 400 may loop back and transmit another communication that includes a different item of content 316. The engagement accelerating system 400 may transmit items of content 316 for a particular maximum number of times and then stop transmitting communications. If the user 202 interacts with an item of content 316 (e.g., logs into the website), the engagement accelerating system 400 may start the loop of selecting and transmitting content items 316 to the user 202 again.

In some example embodiments, if the user 202 is identified to have a high level of awareness, the engagement accelerating system 400 determines that an offer for sale 328 of the product or service 312 may be made to the user 202. In some instances, the engagement accelerating system 400 selects an item of content (e.g., a discount, a promotion, a coupon, etc.) and includes the item of content in the offer for sale 328 to incent the user 202 to purchase the product or service 312.

In some example embodiments, the user 202 consumes the items(s) of content 316 or 322, receives the sale offer 328 but does not buy the product or service 312. The engagement accelerating system 400 may then loop back to determining the propensity 302 of the user 202 to purchase another product or service and communicate other items of content (e.g., news). In some instances, when the individual interest score of the user 202 exceeds a threshold value, engagement accelerating system 400 notifies a sales person to communicate with (e.g., make a phone call to) the user 202.

The engagement accelerating system 400 may perform analyses for the business unit 1 304 and the business unit 2 308 similar to the analysis described above with respect to the business unit 2 306.

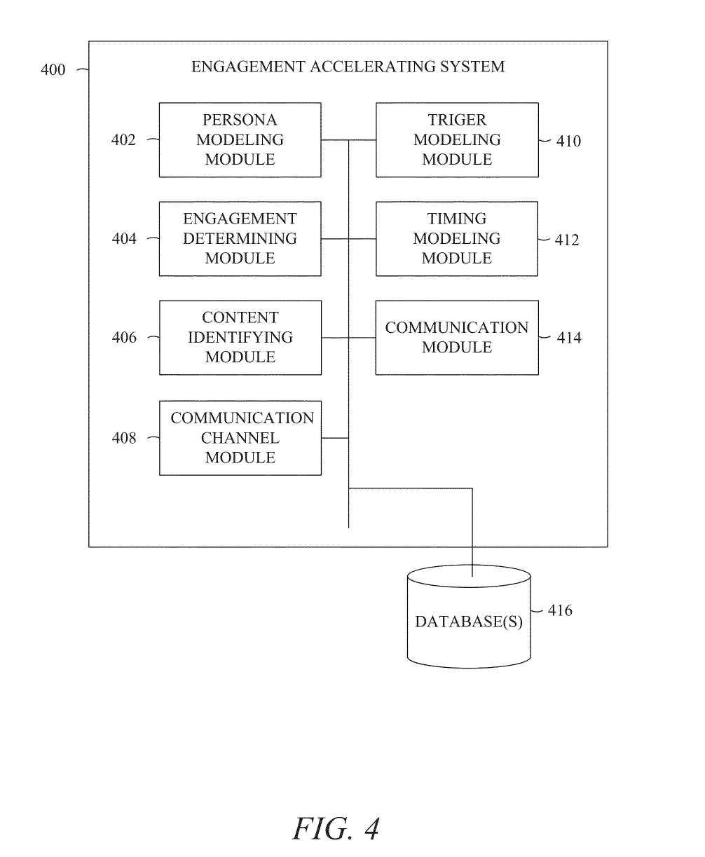

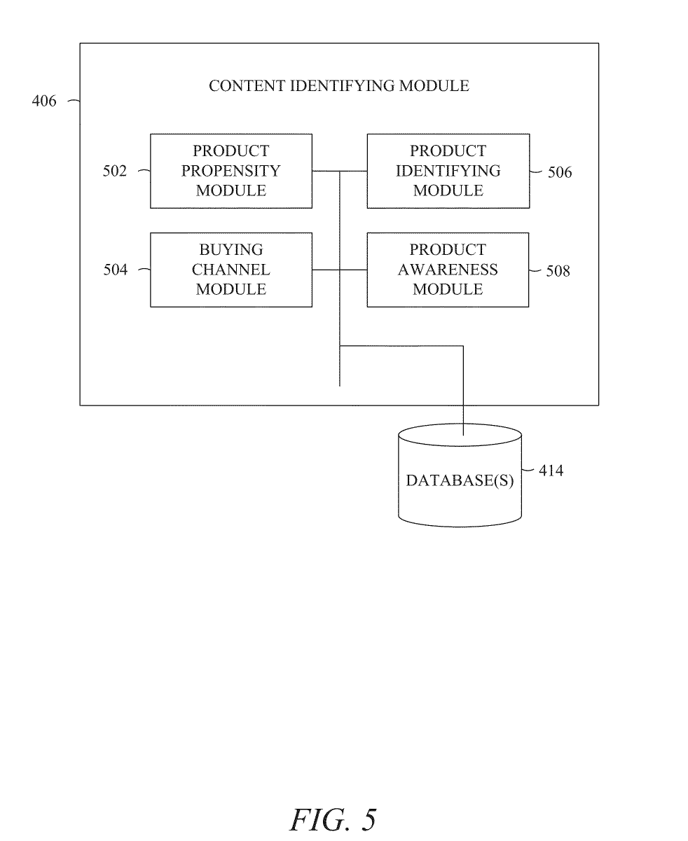

FIG. 4 is a block diagram illustrating components of the engagement accelerating system 400, according to some example embodiments. As shown in FIG. 4, the engagement accelerating system 400 may include a persona modeling module 402, an engagement determining module 404, a content identifying module 406, a communication channel module 408, a trigger modeling module 410, a timing module 404, and a communication module 414, all configured to communicate with each other (e.g., via a bus, shared memory, or a switch). In some example embodiments, the engagement determining module 404 includes one or more additional modules, as discussed below in FIG. 5.

The persona modeling module 402 may access data that pertains to the user 202 in one or more databases and generate a persona for the user 202 based on the data pertaining to the user 202. The persona modeling module 402 may access data that pertains to the employer of the user 202 in one or more databases and generate a persona for the employer of the user 202 based on the data pertaining to the employer of the user 202.

The engagement determining module 404 may determine the level of engagement of the user 202 in the buying cycle. The content identifying module 406 may determine the best (e.g., the optimal) offer or item of content to increase the level of engagement of the user 202. The communication channel module 408 may determine the best (e.g., the optimal) communication channel(s) through which the response rate may be higher (e.g., mobile app, email, ads, video, etc.).

The trigger modeling module 410 may monitor in real time behavioral and other triggers associated with a user, for example, for the purpose of determining the most effective time to communicate with the user (e.g., a potential buyer) based on the circumstances of the user. The timing modeling module 412 may determine the best or (e.g., the optimal) time to communicate the optimal item of content, such as the optimal time of day and the optimal day of the week. A communication module 414 may present (e.g., transmit or display) the optimal item of content to the user 202 via the optimal communication channel at the optimal time of day and the optimal day of the week.

To perform one or more of its functionalities, the engagement accelerating system 400 may communicate with one or more other systems. An integration engine may integrate the engagement accelerating system 400 with one or more email server(s), web server(s), a central asset repository, or other servers or systems. A measurement and reporting engine may determine the performance of one or more modules of the engagement accelerating system 400. An optimization engine may optimize one or more of the models associated with one or more modules of the engagement accelerating system 400.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 416 (e.g., the database 128, the database 130, or the database 132).

FIG. 5 is a block diagram illustrating components of the content identifying module 406 of the engagement accelerating system 400 illustrated in FIG. 4, according to some example embodiments. As shown in FIG. 5, the content identifying module 406 may include a product propensity module 502, a buying channel module 504, a product identifying module 506, and a product awareness module 508, all configured to communicate with each other (e.g., via a bus, shared memory, or a switch). In some example embodiments, the content identifying module 406 includes one or more additional modules.

The product propensity module 502 may determine the propensity of the user 202 to purchase products or services within a business unit. The buying channel module 504 may determine the buying channel appropriate for the user 202 based on one or more seller variables (e.g., a profit or LTV) and one or more buyer variables (e.g., a propensity of the user 202 to buy from a type of channel, a persona of the user 202, the social network of the user 202, the company where the user 202 works, etc.)

The product identifying module 506 may identify a product or service 312 of one or more products or services in the particular business unit 306 that the user 202 may be interested in purchasing. The product awareness module 508 may identify the level of awareness 314 of the user 202 with respect to the identified product or service 312.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 416 (e.g., the database 128, the database 130, or the database 132).

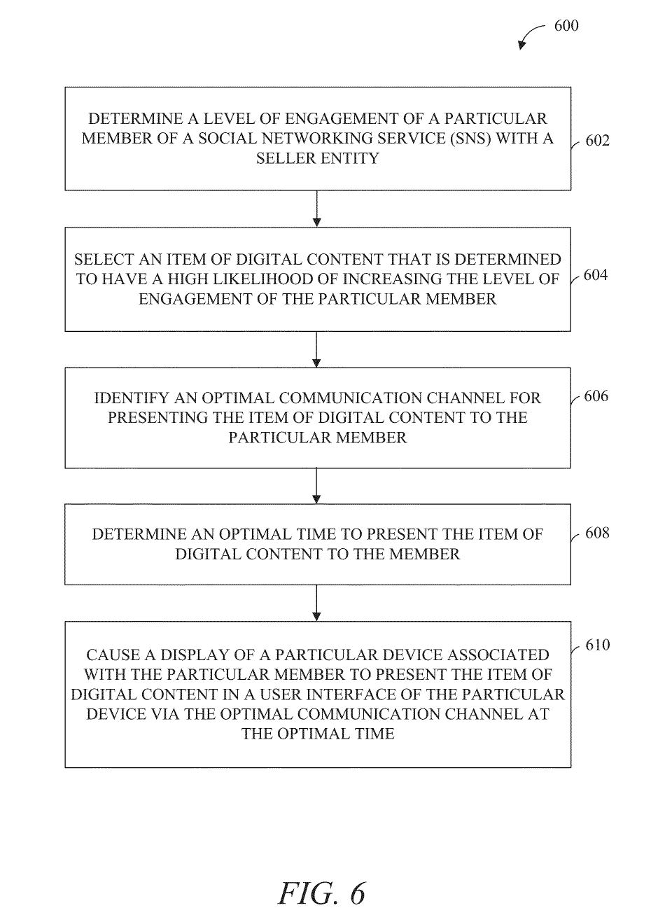

FIGS. 6-10 are flowcharts illustrating a method of accelerating the engagement of a buyer in the buying cycle based on big data analytics, according to some example embodiments. Operations in the method 600 illustrated in FIG. 6 may be performed using modules described above with respect to FIG. 4. As shown in FIG. 6, the method 600 may include one or more of operations 602, 604, 606, 608, and 610.

At method operation 602, the engagement determining module 404 determines a level of engagement of a particular member of a social networking service with a seller entity (e.g., the SNS) that offers a product or service for sale. In some instances, the members of the SNS are identified as disengaged members, moderately engaged members, or fully engaged members. The determining of the level of engagement may be based on a first set of data associated with one or more members of the SNS. The one or more members of the SNS may include the particular member. In some example embodiments, the first set of data is obtained by the SNS based on the one or more members interacting with the SNS via one or more devices associated with the one or more members.

At method operation 604, the content identifying module 406 selects an item of digital content that is determined to have a high likelihood to increase the level of engagement of the particular member. The selecting may be based on the level of engagement of the particular member and on a second set of data associated with one or more members of the SNS. In some instances, the selection of the optimal item of content is performed for the purpose of increasing the level of engagement of the user 202 or of increasing the level of awareness of the user 202 with respect to the identified product or service. In some example embodiments, the second set of data is obtained by the SNS based on the one or more members interacting with the SNS via one or more devices associated with the one or more members.

At method operation 606, the communication channel module 408 identifies an optimal communication channel for presenting the item of digital content to the particular member. The identifying of the optimal communication channel may be based on a third set of data associated with one or more members of the SNS. In some example embodiments, the third set of data is obtained by the SNS based on the one or more members interacting with the SNS via one or more devices associated with the one or more members.

At method operation 608, the timing modeling module 412 determines an optimal time to present the item of digital content to the particular member. The determining of the optimal time may be based on a fourth set of data associated with one or more members of the SNS. In some example embodiments, the fourth set of data is obtained by the SNS based on the one or more members interacting with the SNS via one or more devices associated with the one or more members.

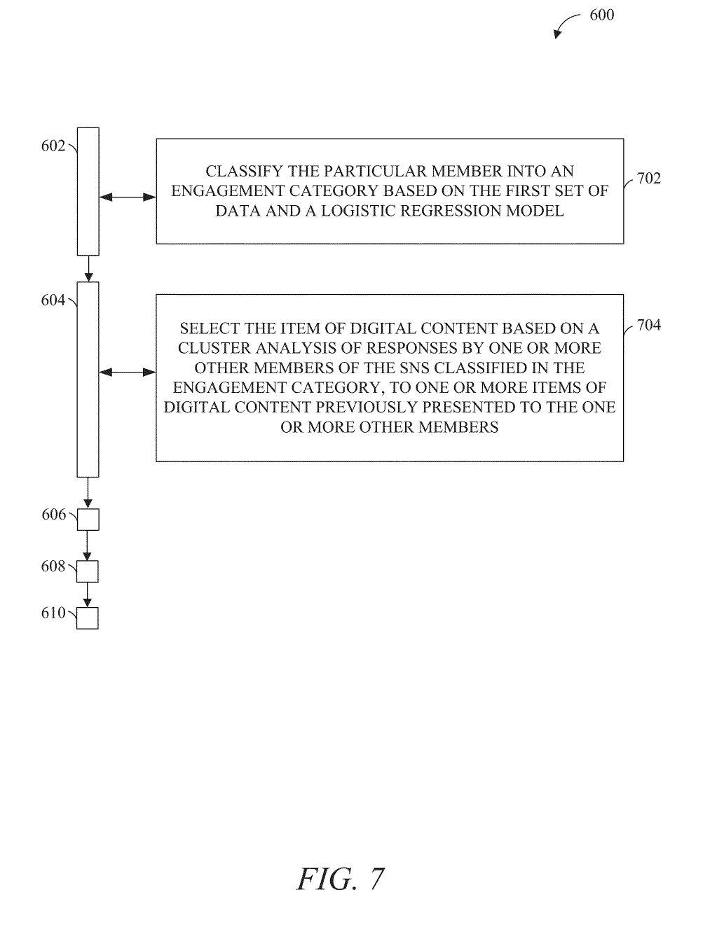

At method operation 610, the communication module 414 causes a display of a particular device associated with the particular member to present the item of digital content in a user interface of the particular device via the optimal communication channel at the optimal time. Further details with respect to the method operations of the method 600 are described below with respect to FIGS. 7-10.

As shown in FIG. 7, the method 600 may include one or more of method operations 702 and 704, according to some example embodiments. Operations in the method 600 illustrated in FIG. 7 may be performed using modules described above with respect to FIG. 4. Method operation 702 may be performed as part (e.g., a precursor task, a subroutine, or a portion) of method operation 602, in which the engagement determining module 404 determines the level of engagement of the particular member with the seller entity that offers a product or service for sale.

At method operation 401, the content identifying module 406 classifies the particular member into an engagement category. The engagement category may identify a phase in a product-learning-buying process. The classifying of the particular member may be based on a first set of data and a logistic regression model. In some example embodiments, the first set of data includes at least one of a number of logins by the particular member, a number of page views by the particular member, a number of days the particular member visited a website, a number of connections of the particular member on the SNS, a number of invites to connect sent by the particular member, a number and a type of searches performed by the particular member, a geographical region identifier, or a preferred language identifier.

Method operation 704 may be performed as part (e.g., a precursor task, a subroutine, or a portion) of method operation 604, in which the content identifying module 406 selects an item of digital content that is determined to have a high likelihood to increase the level of engagement of the particular member. At method operation 704, the content identifying module 406 selects the item of digital content based on a cluster analysis of responses by one or more other members of the SNS classified in the engagement category, to one or more items of digital content previously presented to the one or more other members. The cluster analysis of the responses by the one or more other members to the one or more items of digital content may facilitate an understanding of what content may be received more favorably by certain users at different phases of engagement with a seller entity (e.g., a product or service offered by the seller entity) or which product or service should be sold to the particular member.

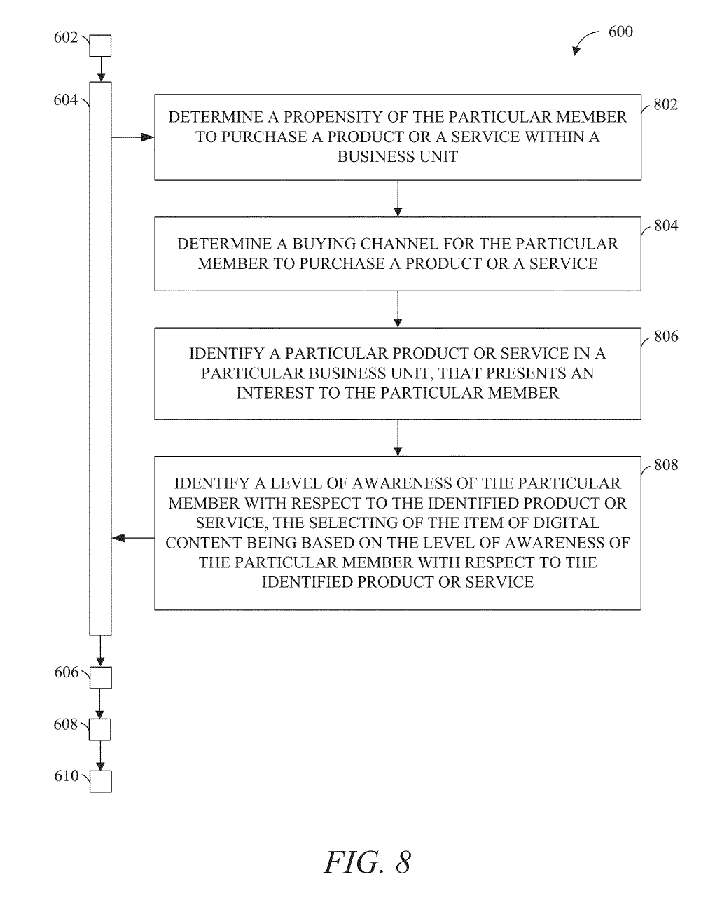

As shown in FIG. 8, the method 600 may include one or more of method operations 802, 804, 806, and 808, according to some example embodiments. Operations in the method 600 illustrated in FIG. 8 may be performed using modules described above with respect to FIG. 5. Method operation 802 may be performed as part (e.g., a precursor task, a subroutine, or a portion) of method operation 604, in which the content identifying module 406 selects an item of digital content that is determined to have a high likelihood to increase the level of engagement of the particular member.

At method operation 802, the product propensity module 502, included in the content identifying module 406, determines a propensity of the particular member to purchase a product or a service within a business unit associated with (e.g. of) the seller entity. The determining of the propensity may be based on a first subset of the second set of data and a logistic regression model. In some example embodiments, the first subset of the second set of data includes at least one of a department identifier associated with a current job of the one or more members, a size of a company that is an employer of the one or more members, a number of employees associated with the company, a revenue number associated with the company, a title identifier of the one or more members, an identifier of a decision making authority of the one or more members associated with the company, a group identifier of a group associated with the one or more members, a preferred language identifier, an indicator of member intent regarding an offer made to the one or more members, the member intent being identified based on member behavior in response to the offer, an identifier of a growth of the company, a number of sales representatives associated with the company, a number of recruiters associated with the company, a number of marketers associated with the company, an indicator of InMail behavior by the one or more members, or an indicator of Invite behavior by the one or more members. In some instances, the logistic regression model is applied to similar data pertaining to users (e.g., members of the SNS) who already purchased a product or service of the seller entity.

Method operation 804 may be performed after method operation 802. At method operation 804, the buying channel module 504, included in the content identifying module 406, determines a buying channel for the particular member to purchase a product or a service. The determining of the buying channel may be based on a second subset of the second set of data and a decision tree model. In some example embodiments, the second subset of the second set of data includes at least one of a number of visits by the one or more members to a website associated with the SNS, a time spent by the one or more members on the website, a number of page views by the one or more members, types of form submissions by the one or more members, a number of email openings by the one or more members, a click-through rate associated with the one or more members, a number of social media mentions associated with the one or more members, a number of tweets associated with the one or more members, a number of follows associated with the one or more members, a number of likes associated with the one or more members, a number of webinar registrations associated with the one or more members, a number of webinar attendances associated with the one or more members, a number of seminar registrations associated with the one or more members, a number of seminar attendances associated with the one or more members, a number of followings of one or more companies on social media by the one or more members, a geographical region identifier, a preferred language identifier, a group identifier of a group associated with the one or more members, or data pertaining to a web form submission by the one or more members. In some instances, the decision tree model is applied to similar data pertaining to users (e.g., members of the SNS) who already purchased a product or service of the seller entity.

In certain example embodiments, the determining of the buying channel for the particular member is further based on seller preference data that represents one or more preferences of the seller entity regarding selling the product or service to the particular member. For example, if the seller preference data indicates that a goal of the seller is to maximize the profit or LTV per user, then the buying channel module 504 selects a buying channel that maximizes the profit or LTV associated with the particular member.

Method operation 806 may be performed after method operation 804. At method operation 806, the product identifying module 506, included in the content identifying module 406, identifies a particular product or service in a particular business unit associated with the seller entity, the product or service relating to an interest of the particular member. In some instances, the product identifying module 506 identifies the most appropriate product or service to be sold to the particular member.

The identifying of the particular product or service may be based on a third subset of the second set of data and a decision tree model. In some example embodiments, the third subset of the second set of data includes at least one of a department identifier associated with a current job of the one or more members, a size of a company that is an employer of the one or more members, a number of employees associated with the company, a revenue number associated with the company, a title identifier of the one or more members, an identifier of a decision making authority of the one or more members associated with the company, a group identifier of a group associated with the one or more members, a preferred language identifier, an indicator of member intent regarding an offer made to the one or more members, the member intent being identified based on member behavior in response to the offer, an identifier of a growth of the company, a number of sales representatives associated with the company, a number of recruiters associated with the company, a number of marketers associated with the company, a past purchase of the product or service by the one or more members, a past purchase of a different product or service in the business unit by the one or more members, a past use of the product or service by the one or more members, an indicator of InMail behavior by the one or more members, or an indicator of Invite behavior by the one or more members. In some instances, the decision tree model is applied to similar data pertaining to users (e.g., members of the SNS) who already purchased a product or service of the seller entity.

Method operation 808 may be performed after method operation 806. At method operation 808, the product awareness module 508, included in the content identifying module 406, identifies a level of awareness of the particular member with respect to the identified product or service. The identifying of the level of awareness may be based on at least one of a past use of the product or service, a SNS connection to another member of the SNS who has used the product or service, or an interaction with an item of digital content pertaining to the product or service. The selecting of the item of digital content may be based on the level of awareness of the particular member with respect to the identified product or service.

In some example embodiments, the particular member may be classified, by the product awareness module 406, into an awareness category (e.g., a low awareness category, a medium awareness category, or a high awareness category) based on the level of awareness of the particular member regarding the identified product or service. The awareness category may correlate to the level of probability that the particular member would buy the product or service. According to certain example embodiments, the classifying of the particular member into an awareness category may inform the selection of the item of digital content to be presented to the particular member. For example, if the product awareness module 508 determines that the particular member knows about the identified product, the engagement accelerating system 400 should not present introductory information about the identified product to the particular member. Alternatively, if particular member is not aware of the identified product, the engagement accelerating system 400 should not present content including a request to buy the product.

According to various example embodiments, the identifying, by the communication channel module 408, of the optimal communication channel for presenting the item of digital content to the particular member includes analyzing the third set of data using a decision tree model. The third set of data, in some instances, includes at least one of a number of unsubscribes associated with one or more communication channels, a conversion rate associated with the one or more channels, a department identifier, a number of employees associated with a company that is an employer of the one or more members, a revenue number associated with the company, a title identifier of the one or more members, an identifier of a decision making authority of the one or more members associated with the company, a geographical region identifier, or a preferred language identifier.

According to various example embodiments, the determining, by the timing modeling module 412, of the optimal time for presenting the item of digital content to the particular member includes analyzing the fourth set of data using a logistic regression model. The fourth set of data, in some instances, includes at least one of an identifier of a decision making authority of the one or more members associated with a company that is an employer of the one or more members, a geographical region identifier, a time zone identifier, a department identifier, an identifier of a size of a company that is an employer of the one or more members, a revenue number associated with the company, a title identifier of the one or more members, a season identifier, or a holiday identifier. In some instances, the logistic regression model is applied to similar data pertaining to users (e.g., members of the SNS) who already purchased a product or service of the seller entity.

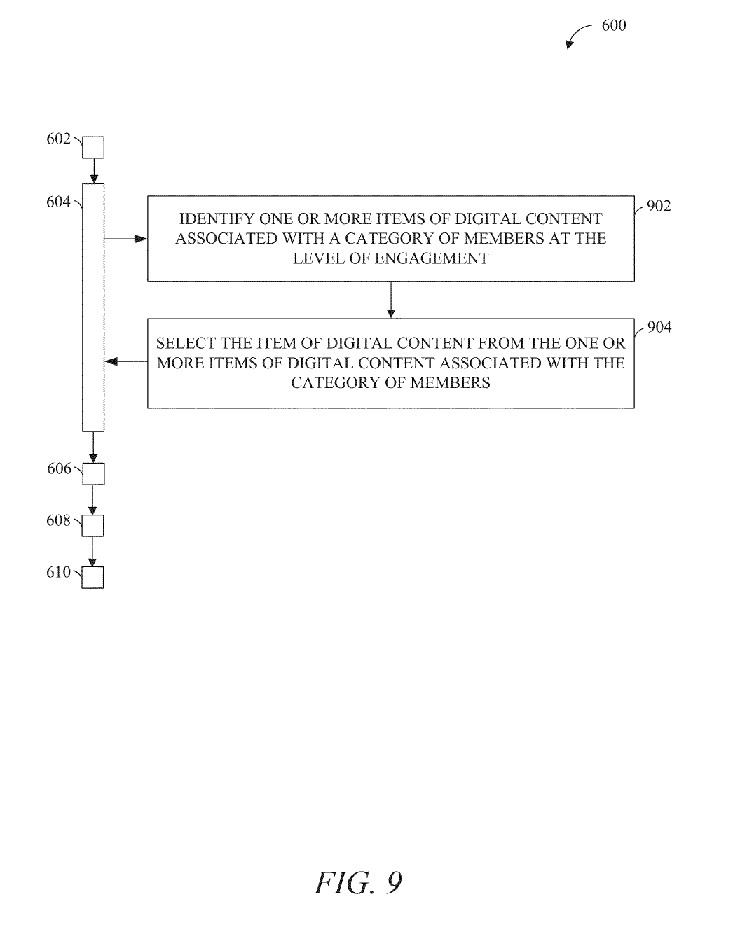

As shown in FIG. 9, the method 600 may include one or more of method operations 902 and 904, according to some example embodiments. Operations in the method 600 illustrated in FIG. 9 may be performed using modules described above with respect to FIG. 4. Method operation 902 may be performed as part (e.g., a precursor task, a subroutine, or a portion) of method operation 604, in which the content identifying module 406 selects an item of digital content that is determined to have a high likelihood to increase the level of engagement of the particular member.

At method operation 902, the content identifying module 406 identifies one or more items of digital content associated with a category of members at the level of engagement of the particular member with the seller entity. The identifying of the one of more items of digital content may be based on the level of engagement of the particular member.

Method operation 904 may be performed after method operation 902. At method operation 902, the content identifying module 406 selects the item of digital content from the one or more items of digital content associated with the category of members. The selecting of the item of digital content may be based on a fourth subset of the second set of data and a logistic regression model. In some example embodiments, the fourth subset of the second set of data includes at least one of a persona identifier, a particular product or service that is identified to present an interest to the one or more members, an indicator that an SNS contact of the particular member is using the particular product or service or a similar product or service, a title identifier of the one or more members, an identifier of a decision making authority of the one or more members associated with a company an employer of the one or more members, an identifier of a particular item of digital content that is presented to members via a plurality of channels, a geographical region identifier, or a preferred language identifier. For example, if a persona of the particular member identifies the particular member as an entrepreneur (e.g., based on one or more attributed associated with entrepreneurs and possessed by the particular member), then the content identifying module 406 selects an item of digital content that is geared toward (or targets) entrepreneurs. Accordingly, a communication that references such item of digital content becomes very crisp and targeted, and can appeal to the needs of the particular member. In some instances, the logistic regression model is applied to similar data pertaining to users (e.g., members of the SNS) who already purchased a product or service of the seller entity.

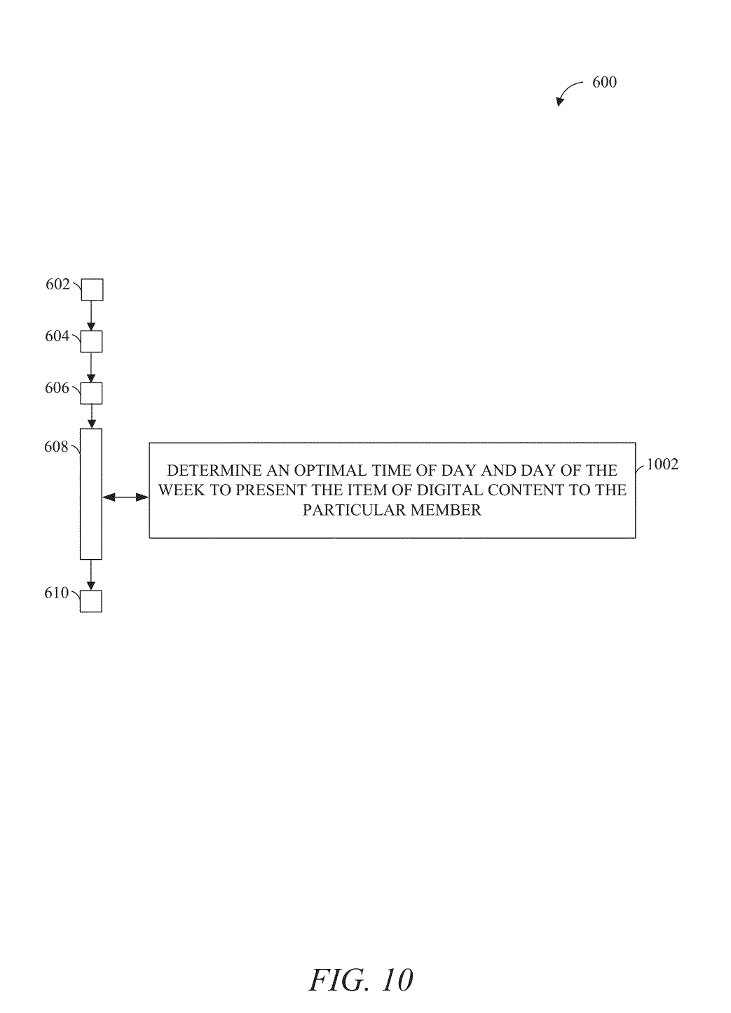

As shown in FIG. 10, the method 600 may include method operation 1002, according to some example embodiments. Method operation 1002 may be performed as part (e.g., a precursor task, a subroutine, or a portion) of method operation 608, in which the timing modeling module 412 determines an optimal time to present the item of digital content to the particular member. At method operation 1002, the timing modeling module 412 determines an optimal time of day and an optimal day of the week to present (e.g., transmit, display, etc.) the item of digital content to the particular member.

### Example Mobile Device

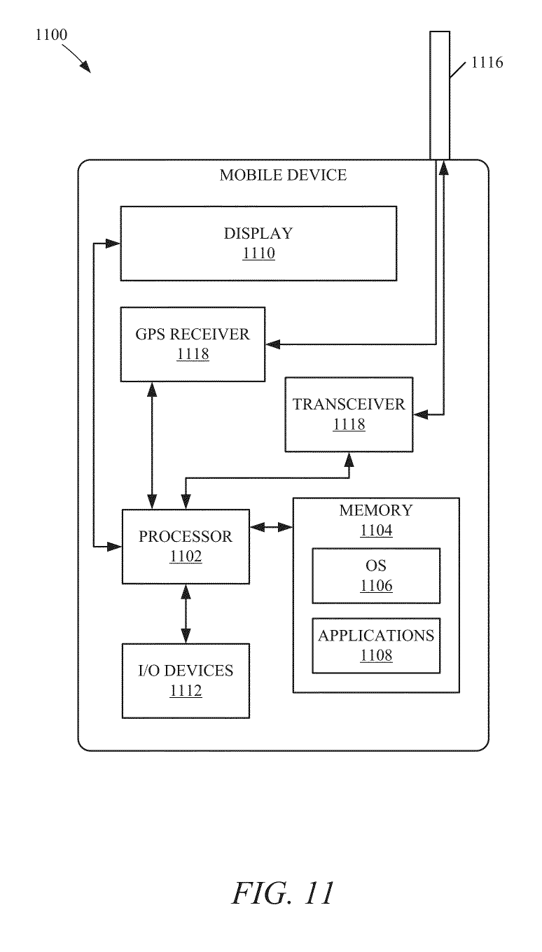

FIG. 11 is a block diagram illustrating a mobile device 1100, according to an example embodiment. The mobile device 1100 may include a processor 1102. The processor 1102 may be any of a variety of different types of commercially available processors 1102 suitable for mobile devices 1100 (for example, an XScale architecture microprocessor, a microprocessor without interlocked pipeline stages (MIPS) architecture processor, or another type of processor 1102). A memory 1104, such as a random access memory (RAM), a flash memory, or other type of memory, is typically accessible to the processor 1102. The memory 1104 may be adapted to store an operating system (OS) 1106, as well as application programs 1108, such as a mobile location enabled application that may provide LBSs to a user. The processor 1102 may be coupled, either directly or via appropriate intermediary hardware, to a display 1110 and to one or more input/output (I/O) devices 1112, such as a keypad, a touch panel sensor, a microphone, and the like. Similarly, in some embodiments, the processor 1102 may be coupled to a transceiver 1114 that interfaces with an antenna 1116. The transceiver 1114 may be configured to both transmit and receive cellular network signals, wireless data signals, or other types of signals via the antenna 1116, depending on the nature of the mobile device 1100. Further, in some configurations, a GPS receiver 1118 may also make use of the antenna 1116 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

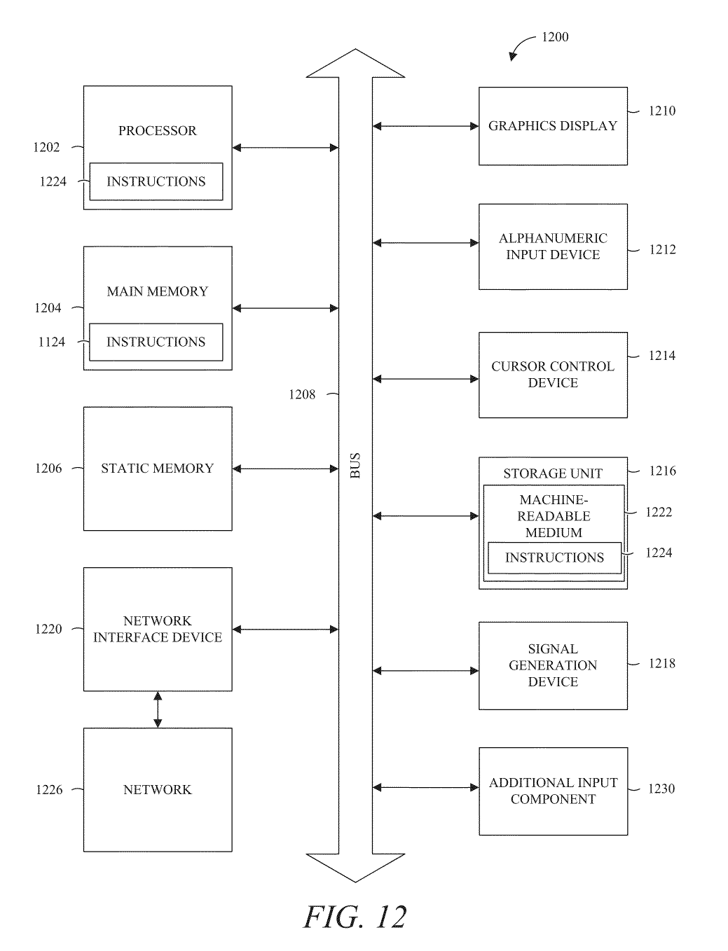

FIG. 12 is a block diagram illustrating components of a machine 1200, according to some example embodiments, able to read instructions 1224 from a machine-readable medium 1222 (e.g., a non-transitory machine-readable medium, a machine-readable storage medium, a computer-readable storage medium, or any suitable combination thereof) and perform any one or more of the methodologies discussed herein, in whole or in part. Specifically, FIG. 12 shows the machine 1200 in the example form of a computer system (e.g., a computer) within which the instructions 1224 (e.g., software, a program, an application, an applet, an app, or other executable code) for causing the machine 1200 to perform any one or more of the methodologies discussed herein may be executed, in whole or in part.

In alternative embodiments, the machine 1200 operates as a standalone device or may be connected (e.g., networked) to other machines. In a networked deployment, the machine 1200 may operate in the capacity of a server machine or a client machine in a server-client network environment, or as a peer machine in a distributed (e.g., peer-to-peer) network environment. The machine 1200 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1224, sequentially or otherwise, that specify actions to be taken by that machine. Further, while only a single machine is illustrated, the term “machine” shall also be taken to include any collection of machines that individually or jointly execute the instructions 1224 to perform all or part of any one or more of the methodologies discussed herein.

The machine 1200 includes a processor 1202 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1204, and a static memory 1206, which are configured to communicate with each other via a bus 1208. The processor 1202 may contain microcircuits that are configurable, temporarily or permanently, by some or all of the instructions 1224 such that the processor 1202 is configurable to perform any one or more of the methodologies described herein, in whole or in part. For example, a set of one or more microcircuits of the processor 1202 may be configurable to execute one or more modules (e.g., software modules) described herein.

The machine 1200 may further include a graphics display 1210 (e.g., a plasma display panel (PDP), a light emitting diode (LED) display, a liquid crystal display (LCD), a projector, a cathode ray tube (CRT), or any other display capable of displaying graphics or video). The machine 1200 may also include an alphanumeric input device 1212 (e.g., a keyboard or keypad), a cursor control device 1214 (e.g., a mouse, a touchpad, a trackball, a joystick, a motion sensor, an eye tracking device, or other pointing instrument), a storage unit 1216, an audio generation device 1218 (e.g., a sound card, an amplifier, a speaker, a headphone jack, or any suitable combination thereof), and a network interface device 1220.

The storage unit 1216 includes the machine-readable medium 1222 (e.g., a tangible and non-transitory machine-readable storage medium) on which are stored the instructions 1224 embodying any one or more of the methodologies or functions described herein. The instructions 1224 may also reside, completely or at least partially, within the main memory 1204, within the processor 1202 (e.g., within the processor's cache memory), or both, before or during execution thereof by the machine 1200. Accordingly, the main memory 1204 and the processor 1202 may be considered machine-readable media (e.g., tangible and non-transitory machine-readable media). The instructions 1224 may be transmitted or received over the network 1226 via the network interface device 1220. For example, the network interface device 1220 may communicate the instructions 1224 using any one or more transfer protocols (e.g., hypertext transfer protocol (HTTP)).

In some example embodiments, the machine 1200 may be a portable computing device, such as a smart phone or tablet computer, and have one or more additional input components 1230 (e.g., sensors or gauges). Examples of such input components 1230 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1222 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1224 for execution by the machine 1200, such that the instructions 1224, when executed by one or more processors of the machine 1200 (e.g., processor 1202), cause the machine 1200 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
determining a level of engagement of a particular member of a social networking service (SNS) with a seller entity that offers a product or service for sale, the determining of the level of engagement being based on a first set of data associated with one or more members of the SNS including the particular member, the first set of data being obtained by the SNS based on the one or more members interacting with the SNS via one or more devices associated with the one or more members;
selecting an item of digital content that is determined to have a high likelihood of increasing the level of engagement of the particular member, the selecting being based on the level of engagement and on a second set of data associated with one or more members of the SNS, the selecting being performed by one or more hardware processors;
identifying an optimal communication channel for presenting the item of digital content to the particular member, the identifying of the optimal communication channel being based on a third set of data associated with one or more members of the SNS;
determining an optimal time to present the item of digital content to the particular member, the determining of the optimal time being based on a fourth set of data associated with one or more members of the SNS; and
causing a display of a particular device associated with the particular member to present the item of digital content in a user interface of the particular device via the optimal communication channel at the optimal time.

2. The method of claim 1, wherein the determining of the level of engagement of the particular member includes classifying the particular member into an engagement category based on the first set of data and a logistic regression model.

3. The method of claim 2, wherein the first set of data includes at least one of a number of logins by the particular member, a number of page views by the particular member, a number of days the particular member visited a website, a number of connections of the particular member on the SNS, a number of invites to connect sent by the particular member, a number and a type of searches performed by the particular member, a geographical region identifier, or a preferred language identifier.

4. The method of claim 2, wherein the selecting of the item of digital content is based on a cluster analysis of responses by one or more other members of the SNS classified in the engagement category, to one or more items of digital content previously presented to the one or more other members.

5. The method of claim 1, wherein the selecting of the item of digital content includes determining a propensity of the particular member to purchase a product or a service within a business unit associated with the seller entity, the determining of the propensity being based on a first subset of the second set of data and a logistic regression model.

6. The method of claim 5, wherein the first subset of the second set of data includes at least one of a department identifier associated with a current job of the one or more members, a size of a company that is an employer of the one or more members, a number of employees associated with the company, a revenue number associated with the company, a title identifier of the one or more members, an identifier of a decision making authority of the one or more members associated with the company, a group identifier of a group associated with the one or more members, a preferred language identifier, an indicator of member intent regarding an offer made to the one or more members, the member intent being identified based on member behavior in response to the offer, an identifier of a growth of the company, a number of sales representatives associated with the company, a number of recruiters associated with the company, a number of marketers associated with the company, an indicator of InMail behavior by the one or more members, or an indicator of Invite behavior by the one or more members.

7. The method of claim 1, wherein the selecting of the item of digital content includes determining a buying channel for the particular member to purchase a product or a service, the determining of the buying channel being based on a second subset of the second set of data and a decision tree model.

8. The method of claim 7, wherein the second subset of the second set of data includes at least one of a number of visits by the one or more members to a website associated with the SNS, a time spent by the one or more members on the website, a number of page views by the one or more members, types of form submissions by the one or more members, a number of email openings by the one or more members, a click-through rate associated with the one or more members, a number of social media mentions associated with the one or more members, a number of tweets associated with the one or more members, a number of follows associated with the one or more members, a number of likes associated with the one or more members, a number of webinar registrations associated with the one or more members, a number of webinar attendances associated with the one or more members, a number of seminar registrations associated with the one or more members, a number of seminar attendances associated with the one or more members, a number of followings of one or more companies on social media by the one or more members, a geographical region identifier, a preferred language identifier, a group identifier of a group associated with the one or more members, or data pertaining to a web form submission by the one or more members.

9. The method of claim 7, wherein the determining of the buying channel for the particular member is further based on seller preference data that represents one or more preferences of the seller entity regarding selling the product or service to the particular member.

10. The method of claim 1, wherein the selecting of the item of digital content includes identifying a particular product or service in a particular business unit associated with the seller entity, the product or service relating to an interest of the particular member, the identifying of the particular product or service being based on a third subset of the second set of data and a decision tree model.

11. The method of claim 10, wherein the third subset of the second set of data includes at least one of a department identifier associated with a current job of the one or more members, a size of a company that is an employer of the one or more members, a number of employees associated with the company, a revenue number associated with the company, a title identifier of the one or more members, an identifier of a decision making authority of the one or more members associated with the company, a group identifier of a group associated with the one or more members, a preferred language identifier, an indicator of member intent regarding an offer made to the one or more members, the member intent being identified based on member behavior in response to the offer, an identifier of a growth of the company, a number of sales representatives associated with the company, a number of recruiters associated with the company, a number of marketers associated with the company, a past purchase of the product or service by the one or more members, a past purchase of a different product or service in the business unit by the one or more members, a past use of the product or service by the one or more members, an indicator of InMail behavior by the one or more members, or an indicator of Invite behavior by the one or more members.

12. The method of claim 10, further comprising identifying a level of awareness of the particular member with respect to the identified product or service, the identifying of the level of awareness being based on at least one of a past use of the product or service, a SNS connection to another member of the SNS who has used the product or service, or an interaction with an item of digital content pertaining to the product or service, and
wherein the selecting of the item of digital content is based on the level of awareness of the particular member with respect to the identified product or service.

13. The method of claim 1, wherein the selecting of the item of digital content includes:
identifying, based on the level of engagement, one or more items of digital content associated with a category of members at the level of engagement; and
selecting the item of digital content from the one or more items of digital content associated with the category of members, based on a fourth subset of the second set of data and a logistic regression model.

14. The method of claim 13, wherein the fourth subset of the second set of data includes at least one of a persona identifier, a particular product or service that is identified to present an interest to the one or more members, an indicator that an SNS contact of the particular member is using the particular product or service or a similar product or service, a title identifier of the one or more members, an identifier of a decision making authority of the one or more members associated with a company an employer of the one or more members, an identifier of a particular item of digital content that is presented to members via a plurality of channels, a geographical region identifier, or a preferred language identifier.

15. The method of claim 1, wherein the identifying of the optimal communication channel for presenting the item of digital content to the particular member includes analyzing the third set of data using a decision tree model.

16. The method of claim 15, wherein the third set of data includes at least one of a number of unsubscribes associated with one or more communication channels, a conversion rate associated with the one or more channels, a department identifier, a number of employees associated with a company that is an employer of the one or more members, a revenue number associated with the company, a title identifier of the one or more members, an identifier of a decision making authority of the one or more members associated with the company, a geographical region identifier, or a preferred language identifier.

17. The method of claim 1, wherein the determining of the optimal time for presenting the item of digital content to the particular member includes analyzing the fourth set of data using a logistic regression model.

18. The method of claim 17, wherein the fourth set of data includes at least one of an identifier of a decision making authority of the one or more members associated with a company that is an employer of the one or more members, a geographical region identifier, a time zone identifier, a department identifier, an identifier of a size of a company that is an employer of the one or more members, a revenue number associated with the company, a title identifier of the one or more members, a season identifier, or a holiday identifier.

19. A system comprising:
a memory for storing instructions; and
a hardware processor, which, when executing the instructions, causes the system to:
determine a level of engagement of a particular member of a social networking service (SNS) with a seller entity that offers a product or service for sale, the determining of the level of engagement being based on a first set of data associated with one or more members of the SNS including the particular member, the first set of data being obtained by the SNS based on the one or more members interacting with the SNS via one or more devices associated with the one or more members,
select an item of digital content that is determined to have a high likelihood of increasing the level of engagement of the particular member, the selecting being based on the level of engagement and on a second set of data associated with one or more members of the SNS, the selecting being performed by one or more hardware processors,
identify an optimal communication channel for presenting the item of digital content to the particular member, the identifying of the optimal communication channel being based on a third set of data associated with one or more members of the SNS,
determine an optimal time to present the item of digital content to the particular member, the determining of the optimal time being based on a fourth set of data associated with one or more members of the SNS, and
cause a display of a particular device associated with the particular member to present the item of digital content in a user interface of the particular device via the optimal communication channel at the optimal time.

20. A non-transitory machine-readable storage medium comprising instructions that, when executed by one or more processors of a machine, cause the machine to perform operations comprising:
determining a level of engagement of a particular member of a social networking service (SNS) with a seller entity that offers a product or service for sale, the determining of the level of engagement being based on a first set of data associated with one or more members of the SNS including the particular member, the first set of data being obtained by the SNS based on the one or more members interacting with the SNS via one or more devices associated with the one or more members;
selecting an item of digital content that is determined to have a high likelihood of increasing the level of engagement of the particular member, the selecting being based on the level of engagement and on a second set of data associated with one or more members of the SNS, the selecting being performed by one or more hardware processors;
identifying an optimal communication channel for presenting the item of digital content to the particular member, the identifying of the optimal communication channel being based on a third set of data associated with one or more members of the SNS;
determining an optimal time to present the item of digital content to the particular member, the determining of the optimal time being based on a fourth set of data associated with one or more members of the SNS; and
causing a display of a particular device associated with the particular member to present the item of digital content in a user interface of the particular device via the optimal communication channel at the optimal time.
